(19) United States
(12) Patent Application Publication
(10) Pub. No.: US 2003/0222753 A1
(43) Pub. Date: Dec. 4, 2003

(54) Automobile safety cutout with a fault indicator

(76) Inventor: Chwen-Ru Lin, Changhua City (TW)

Correspondence Address: CHWEN-RU LIN, PO BOX 487, Chang-Hua City 500, TW

(21) Appl. No.: 10/446,794

(22) Filed: May 29, 2003

(30) Foreign Application Priority Data
Jun. 3, 2002 (TW) 91208306

(51) Int. Cl. H01H 85/30; H01H 85/32

(52) U.S. Cl. 337/206; 337/242

(57) ABSTRACT

An automobile safety cutout with a fault indicator comprises an electric light emitting object, a fuse, two electrodes that are linked by the fuse and are wired respectively to each terminal of the electric light emitting object, and an insulating case. The fuse blows when a circuit the automobile safety cutout protects experiences an anomalous electricity supply or a short circuit, which results in a difference in electric potential between the electrodes. Because automobile electricity supply is of direct current, this potential difference is steady. The electric light emitting object straddling the electrodes is then powered by the potential difference, and is lighted up.

### FIELD OF THE INVENTION

The present invention relates to an automobile safety cutout with a fault indicator, and more particularly to an automobile safety cutout with a fault indicator in which an electric light emitting object is lighted up when a fuse blows.

### BACKGROUND OF THE INVENTION

Automobile safety cutouts of the prior art, as shown in FIG. 1, are used to protect circuit elements in an automobile circuitry. Nevertheless, it is difficult to identity which safety cutout is faulted, due to its lack of an appropriate indicator. Once a safety cutout is faulted, a wide range of circuit system should be checked before the safety cutout is found. This is inconvenient for a mechanic to replace a faulted safety cutout. With the help of the fault indicator, even an ordinary person can easily fix a faulted circuit.

Automobile safety cutouts with a fault indicator of the prior art use a spring to be bound with a fuse and an electric light emitting object connected to the spring; the light emitting object is usually a light emitting diode (LED). As the fuse blows, the spring is no more constrained by the fuse and extends itself to contact one electrode; being connected to an electric power source, the electric light emitting object is then lighted up.

However, the structure of a conventional automobile safety cutout with a fault indicator is so complicated that mass production is not cost-effective. It is therefore necessary to invent a simpler mechanism for lighting up an electric light emitting object.

### SUMMARY OF THE INVENTION

Accordingly, the primary object of the present invention is to provide an automobile safety cutout with a fault indicator comprising an insulating case and a fault-indicating device. The fault-indicating device is further composed of an electric light emitting object, a fuse, two electrodes that are linked by the fuse and are wired respectively to each terminal of the electric light emitting object. When the fuse blows, the electric potential difference formed between the electrodes lights up the electric light emitting object.

This automobile safety cutout with a fault indicator utilizes a condition of abnormal electric supply to light up an electric light emitting object, indicating the associated automobile safety cutout is in a fault. The indicator facilitates replacing the faulted safety cutout.

The various objects and advantages of the present invention will be more readily understood from the following detailed description when read in conjunction with the appended-drawing.

### BRIEF DESCRIPTION OF THE DRAWINGS

FIG. 1 is a side view of an automobile safety cutout of the prior art.

FIG. 2 is a side view of an automobile safety cutout with a fault indicator according to the present invention in normal condition.

FIG. 3 is a side view of an automobile safety cutout with a fault indicator according to the present invention in faulted condition.

FIG. 4 is the circuit diagram of an automobile safety cutout with a fault indicator according to the present invention in normal condition.

FIG. 5 is the circuit diagram of an automobile safety cutout with a fault indicator according to the present invention in faulted condition.

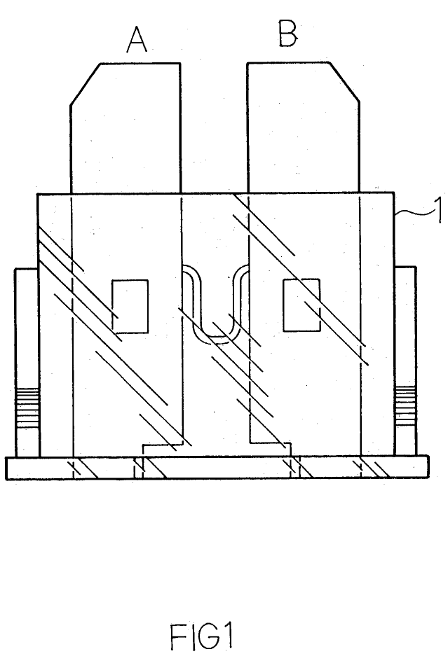

### DETAILED DESCRIPTION OF THE PREFERRED EMBODIMENTS

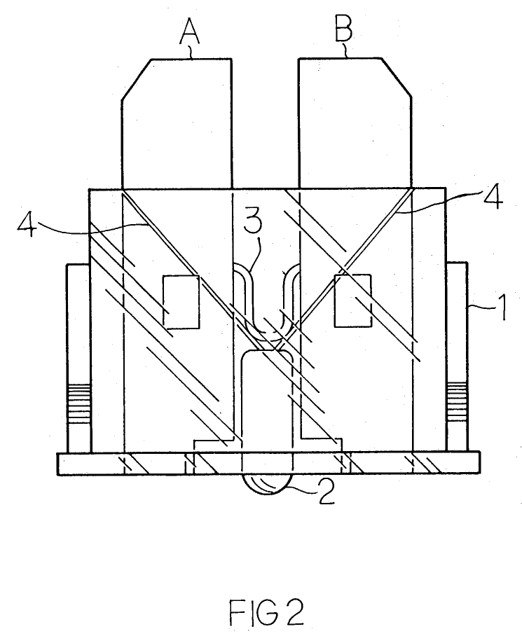

Referring to FIG. 2, an automobile safety cutout with a fault indicator according to the present invention comprises an insulating case 1 and two electrodes A and B, which electrodes are linked together by a fuse 3 and respectively connected to two terminals of an electric light emitting object 2 by a pair of wires 4. The electric light emitting object 2 can be a light emitting diode (LED).

The automobile safety cutout with a fault indicator utilizes a condition of abnormal electric supply to light up an electric light emitting object, indicating the associated automobile safety cutout is in a fault. The indicator facilitates replacing the faulted safety cutout.

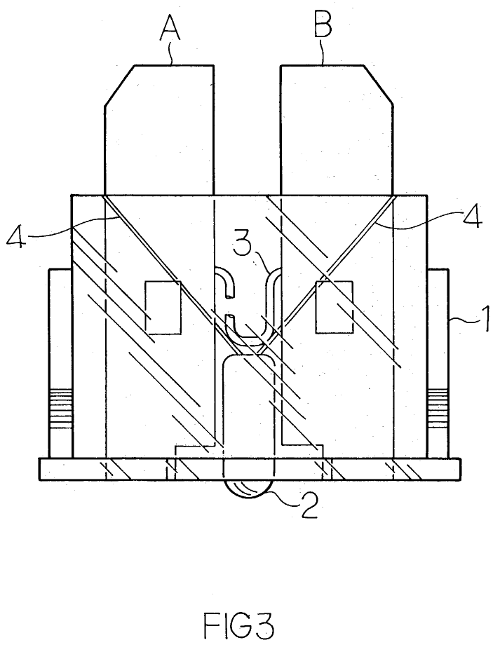

The working principle of the automobile safety cutout with a fault indicator is described as follows. As shown in FIG. 3, when electrodes A and B are overloaded electrically, the fuse 3 linking them will blow, resulting in a difference in electric potential between electrodes A and B. Because automobile electricity supply is of direct current, this potential difference is steady. Supplied with the potential difference by wires 4, the electric light emitting object 2 lights up. To replace a faulted safety cutout, the electricity switch of a car is turned on, and the safety cutout with its indicator on is then replaced.

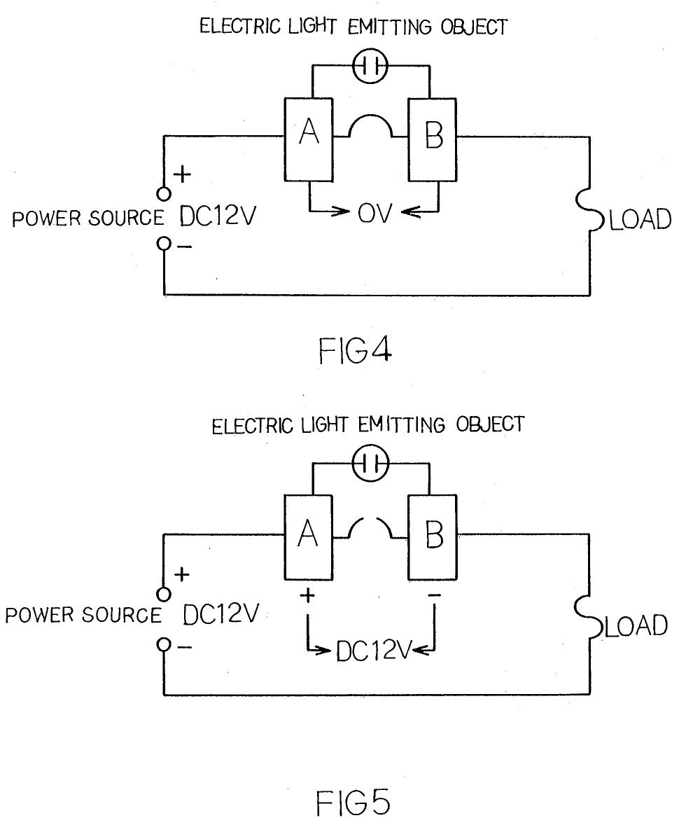

FIG. 4 is the circuit diagram of the automobile safety cutout with a fault indicator according to the present invention. Under normal condition the electrodes A, B and the fuse 3, form a part of a circuit, wherein an electric current passes through. When the circuit malfunctions or the load applied to the circuit is too high, the fuse 3 blows. As indicated in FIG. 5, there is then a potential difference between the electrodes A and B. When applied to the electric light emitting object 2 by the pair of wires 4, the potential difference lights up the electric light emitting object 2.

The present invention is thus described, and it will be obvious that the same invention may be varied in many ways. Such variations are not to be regarded as a departure from the spirit and scope of the present invention, and all such modifications as would be obvious to one skilled in the art are intended to be included within the scope of the following claims.

What is claimed is:

1. An automobile safety cutout with a fault indicator comprising:
a fault-indicating device having an electric light emitting object, a fuse, and two electrodes that are linked by the fuse and are wired respectively to each terminal of the electric light emitting object; and
an insulating case receiving the fault indicating device;
the fuse blowing when a circuit the automobile safety cutout with a fault indicator protects experiencing an anomalous electricity supply or a short circuit, resulting in a difference in electric potential between the electrodes; the electric light emitting object straddling the electrodes being powered by the potential difference and-being lighted up.

2. The automobile safety cutout with a fault indicator of claim 1, wherein said electric light emitting object is a light emitting diode (LED).
